(19) United States
(12) Patent Application Publication
(10) Pub. No.: US 2008/0286601 A1
(43) Pub. Date: Nov. 20, 2008

(54) PART MACHINING METHOD, MOLD, LONG PART, TABLE APPARATUS, AND X-RAY IMAGING SYSTEM

(76) Inventors: Baskar Somasundaram, Bangalore (IN); Shaji Alakkat, Bangalore (IN)

Correspondence Address: Patrick W. Rasche;Armstrong Teasdale LLP, Suite 2600, One Metropolitan Square, St. Louis, MO, 63102, US

(21) Appl. No.: 11/835,464

(22) Filed: Aug. 8, 2007

(30) Foreign Application Priority Data
Aug. 9, 2006 (JP) 2006-217075

(51) Int. Cl. B32B 15/01; B29C 70/74

(52) U.S. Cl. 428/615; 264/334; 425/110

(57) ABSTRACT

A method for machining the surface of a long metal member flatwise substantially throughout the overall length of the surface, a mold for the machining, a machined long part, a table apparatus using the machined part, and an X-ray imaging system using the table apparatus, are to be provided. The machining method comprises the steps of positioning a mold in such a manner that a flat mold surface is opposed to a surface of a long metal member in a state of non-contact substantially throughout the overall length of the surface, filling a metal adhesive agent into the opposed portion between the long metal member and the mold, and removing the mold after curing of the metal adhesive agent.

### BACKGROUND OF THE INVENTION

The present invention relates to a part machining method, a mold, a long part, a table apparatus and an X-ray imaging system. Particularly, the present invention is concerned with a method for machining the surface of a long metal member, a mold to be used for machining the surface of the long metal member, a long part having a machined surface, a table apparatus using such a part, and an X-ray imaging system having such a table apparatus.

An X-ray imaging system has a table apparatus for supporting a subject. The table apparatus supports a subject with use of a top board which is movable rectilinearly in the longitudinal direction. In accordance with a position to be radiographed the table apparatus causes the top board to move longitudinally to effect positioning of the subject. (See, for example, Patent Literature 1.)

The rectilinear movement of the top board is performed using a motor as a drive source. A rack and a pinion are used to move the top board rectilinearly by the motor. The rack which is mounted on the top board side is driven by the pinion which is mounted on the motor side.

The rectilinear movement of the top board is restricted by a linear guide which is integral with the top board. The linear guide is constituted by a C-channel having a rail in its inside. The rack is attached to a side face of the C-channel. The C-channel is a relatively thin and long metal member having, for example, a length of about 2000 mm, a width of about 50 mm and a thickness of about 8 mm.

[Patent Literature 1] U.S. Pat. No. 5,590,429

For enhancing the smoothness of quietness of the rectilinear movement, the rack-mounted side face of the C-channel must be flat highly accurately throughout the overall length and be parallel to the linear guide. However, due to a limit encountered in the machining process now in use, it is difficult to fabricate a C-channel having a rack mounting surface which is flat highly accurately throughout the overall length. Moreover, because of absence of any appropriate reference, it is difficult to make the rack mounting surface parallel to the linear guide.

If the C-channel is made fully thick, the flatness of the rack mounting surface can be improved even by the machining process now in use. But there arise such inconveniences as a decrease of the radiographable range and an increase of weight.

### SUMMARY OF THE INVENTION

Therefore, it is an object of the present invention to provide a method capable of machining the surface of a long metal member flatwise substantially throughout the overall length, a mold for performing such machining, a long part having a flatwise machined surface substantially throughout the overall length, a table apparatus using such a part, and an X-ray imaging system having such a table apparatus.

In one aspect of the present invention for solving the above-mentioned problems there is provided a part machining method comprising the steps of positioning a mold in such a manner that a flat mold surface is opposed to a surface of a long metal member in a state of non-contact substantially throughout the overall length of the surface, filling a metal adhesive agent into the opposed portion between the long metal member and the mold, and removing the mold after curing of the metal adhesive agent.

Preferably, the long metal member has a rectilinear rail in the longitudinal direction, and positioning of the mold is performed in relation to the rail in such a manner that the mold surface becomes parallel to the rail, which is preferred for making a surface of the metal adhesive agent parallel to the rail.

For obtaining a long metal member having a rack parallel to a rail it is preferable for the method to further comprise the step of mounting a rack to a surface of the metal adhesive agent corresponding to the mold surface in such a manner that the rack is parallel to the rail.

In another aspect of the present invention for solving the foregoing problems there is provided a mold comprising a reference surface capable of abutment against a reference position which is determined by a predetermined portion of a long metal member to be molded, and a mold surface opposed in parallel to the reference surface through a predetermined spacing and capable of being opposed to a surface of the long metal member in a state of non-contact substantially throughout the overall length of the surface.

For obtaining a reference position determined by a rail it is preferable that the predetermined portion be a rectilinear rail attached to the long metal member longitudinally.

In a further aspect of the present invention for solving the foregoing problems there is provided a long part comprising a long metal member and a metal adhesive agent molded to a surface of the long metal member substantially throughout the overall length of the surface so as to provide a flat surface.

For obtaining a long part having a surface parallel to a rail it is preferable that the long metal member have a rectilinear rail in the longitudinal direction and that the surface of the metal adhesive agent be parallel to the rail.

For obtaining a long metal member having a rack parallel to the rail it is preferable for the long part to further comprise a rack mounted to the surface of the metal adhesive agent so as to be parallel to the rail.

In a still further aspect of the present invention for solving the foregoing problems there is provided a table apparatus comprising a top board and a moving mechanism for moving the top board rectilinearly in the longitudinal direction, the moving mechanism comprising a long metal member mounted to the top board longitudinally, a rectilinear rail mounted to the long metal member longitudinally, a rail block engaged with the rail, a metal adhesive agent molded to a surface of the long metal member in parallel with the rail substantially throughout the overall length of the surface so as to provide a flat surface, a rack mounted to the surface of the metal adhesive agent so as to be parallel to the rail, and a pinion engaged with the rack.

In a still further aspect of the present invention there is provided an X-ray imaging system comprising an X-ray irradiator, an X-ray detector and a table apparatus, the table apparatus comprising a top board and a moving mechanism for moving the top board rectilinearly in the longitudinal direction, the moving mechanism comprising a long metal member mounted to the top board longitudinally, a rectilinear rail mounted to the long metal member longitudinally, a rail block engaged with the rail, a metal adhesive agent molded to a surface of the long metal member in parallel with the rail substantially throughout the overall length of the surface so as to provide a flat surface, a rack mounted to the surface of the metal adhesive agent so as to be parallel to the rail, and a pinion engaged with the rack.

For the reduction of weight it is preferable that the long metal member be a C-channel.

Since the part machining method in one aspect of the present invention comprises the steps of positioning a mold in such a manner that a flat mold surface is opposed to a surface of a long metal member in a state of non-contact substantially throughout the overall length of the surface, filling a metal adhesive agent into the opposed portion between the long metal member and the mold, and removing the mold after curing of the metal adhesive agent, the surface of the long metal member can be machined flatwise substantially throughout the overall length thereof by the method.

Since the mold in another aspect of the present invention comprises a reference surface capable of abutment against a reference position which is determined by a predetermined portion of a long metal member to be molded, and a mold surface opposed in parallel to the reference surface through a predetermined spacing and capable of being opposed to a surface of the long metal member in a state of non-contact substantially throughout the overall length of the surface, the surface of the long metal member can be machined flatwise substantially throughout the overall length thereof by the mold.

Since the long part in a further aspect of the present invention comprises a long metal member and a metal adhesive agent molded to a surface of the long metal member substantially throughout the overall length of the surface so as to provide a flat surface, the long part can have a flatwise machined surface substantially throughout the overall length thereof.

Since the table apparatus in a still further aspect of the present invention comprises a top board and a moving mechanism for moving the top board rectilinearly in the longitudinal direction, the moving mechanism comprising a long metal member mounted to the top board longitudinally, a rectilinear rail mounted to the long metal member longitudinally, a rail block engaged with the rail, a metal adhesive agent molded to a surface of the long metal member in parallel with the rail substantially throughout the overall length of the surface so as to provide a flat surface, a rack mounted to the surface of the metal adhesive agent so as to be parallel to the rail, and a pinion engaged with the rack, the table apparatus can have such a moving mechanism as is constituted by a long part with a rack attached to the surface machined flatwise substantially throughout the overall length thereof.

Since the X-ray imaging system in a still further aspect of the present invention comprises an X-ray irradiator, an X-ray detector and a table apparatus, the table apparatus comprising a top board and a moving mechanism for moving the top board rectilinearly in the longitudinal direction, the moving mechanism comprising a long metal member mounted to the top board longitudinally and a rectilinear rail mounted to the long metal member longitudinally, a rail block engaged with the rail, a metal adhesive agent molded to a surface of the long metal member in parallel with the rail substantially throughout the overall length of the surface so as to provide a flat surface, a rack mounted to the surface of the metal adhesive agent so as to be parallel to the rail, and a pinion engaged with the rack, the X-ray imaging apparatus can have a table apparatus provided with such a moving mechanism as is constituted by a long part with a rack attached to the surface machined flatwise substantially throughout the overall length thereof.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the construction of an X-ray imaging system as an example of the best mode for carrying out the present invention;

FIG. 2 is a diagrams showing the construction of a long part as another example of the best mode for carrying out the present invention;

FIG. 3 is a diagram showing the construction of a mold as a further example of the best mode for carrying out the present invention;

FIG. 4 is a diagram showing a step in a part machining method as a still further example of the best mode for carrying out the present invention;

FIG. 5 is a diagram showing another step in the part machining method;

FIG. 6 is a diagram showing a further step in the part machining method; and

FIG. 7 is a diagram showing a still further step in the part machining method.

### DETAILED DESCRIPTION OF THE INVENTION

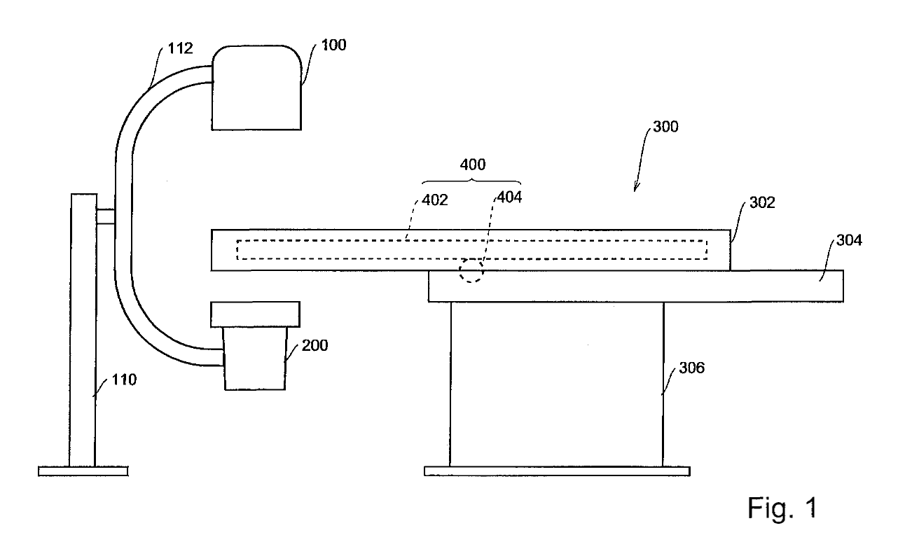

The best mode for carrying out the present invention will be described in detail hereinunder with reference to the drawings. The present invention is not limited to the best mode. FIG. 1 shows a schematic construction of an X-ray imaging system. This system is an example of the best mode. With the construction of this apparatus, there is shown an example of the best mode with respect to the X-ray imaging system.

As shown in FIG. 1, this system includes an X-ray irradiator 100, an X-ray detector 200 and a table apparatus 300.

The X-ray irradiator 100 is an example of the X-ray irradiator defined in the present invention. The X-ray detector 200 is an example of the X-ray detector defined in the present invention. The table apparatus 300 is an example of the table apparatus defined in the present invention. Further, the table apparatus 300 is an example of the best mode for carrying out the present invention. With a part of the construction of the table apparatus 300, there is shown an example of the best mode for carrying out the present invention with respect to the table apparatus.

The X-ray irradiator 100 and the X-ray detector 200 are mounted in opposition to each other at both ends of a C arm 112 of a stand 110. The table apparatus 300 includes a top board 302, a top board support 304 and a stand 306. The top board 302 is supported by the top board support 304. The top board support 304 is supported by the stand 306. The stand 306 is constructed so that it can change the height and inclination angle of the top board support 304.

The top board 302 is constructed so that it can move forward and backward rectilinearly in the longitudinal direction on the top board support 304. The rectilinear movement of the top board 302 is performed by a moving mechanism 400 provided in the top board support 304. The top board 302 is an example of the top board defined in the present invention. The moving mechanism 400 is an example of the moving mechanism defined in the present invention.

The moving mechanism 400 includes a rack and a pinion. From the top board support 304 side a pinion 404 engages a rack 402 which is disposed in the longitudinal direction of the top board 302. The pinion is driven by a motor. The rack 402 is an example of the rack defined in the present invention. The pinion 404 is an example of the pinion defined in the present invention.

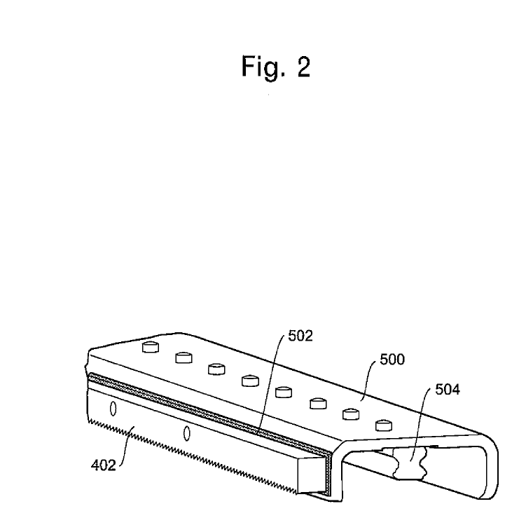

FIG. 2 shows the construction of a rack mounting portion. As shown in the same figure, the rack 402 is mounted to a side face of a C-channel 500. The C-channel 500 is a long metal member attached to both sides of the top board 302. The rack 402 is attached to any one side of the rack 402.

The C-channel 500 is, for example, a long metal member having a length of about 2000 mm, a width of about 50 mm and a thickness of about 8 mm. The C-channel is an example of the long metal member defined in the present invention and is also an example of C-channel defined in the present invention. By using the C-channel as the long metal member it is possible to attain the reduction in weight of the part.

A layer of a metal adhesive agent 502 is formed beforehand on a side face of the C-channel 500 and the rack 402 is attached to the C-channel with screws or the like in a state in which a side face thereof is abutted against the surface of the layer of the metal adhesive agent 502. The thickness of the layer of the metal adhesive agent 502 is, for example, about 2 mm. The metal adhesive agent 502 is an example of the metal adhesive agent defined in the present invention.

As the metal adhesive agent 502 there is used, for example, Moglice (trade name, a product of DIAMANT Co.). The layer of the metal adhesive agent may also be referred to as the metal adhesive layer. The C-channel 500 having the metal adhesive layer 502 is an example of the long part defined in the present invention. Further, the C-channel 500 having the metal adhesive layer 502 is an example of the best mode for carrying out the present invention. With the C-channel 500 having the metal adhesive layer 502, there is shown an example of the best mode for carrying out the present invention with respect to the long part.

The C-channel 500 has a rail 504 in its inside. The rail 504 is a highly accurately rectilinear rail free of bend or undulation and is attached to the C-channel 500 longitudinally with screws or the like. The rail 504 constitutes a linear guide together with a corresponding rail block. The rail block is provided on the top board support 304 side. The rail 504 is an example of the rail defined in the present invention. The rail block is an example of the rail block defined in the present invention.

The metal adhesive layer 502 is formed by a method to be described later so that the surface thereof is highly accurately flat substantially throughout the overall length of the C-channel 500 and is parallel to the rail 504. Therefore, the rack 402 attached to that surface becomes highly accurately parallel to the rail 504. Consequently, the rectilinear movement of the top board 302 by the moving mechanism 400 is smooth and quiet. Besides, since it is not necessary to increase the thickness of the C-channel, the radiographable range does not decrease nor is there an increase of weight.

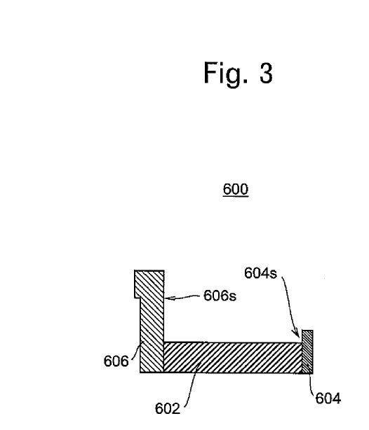

A description will now be given about a method for forming the metal adhesive layer 502. For forming the metal adhesive layer 502 there is used such a mold 600 as shown in FIG. 3. The mold 600 is an example of the best mode for carrying out the present invention. With the construction of this mold, there is shown an example of the best mode for carrying out the present invention with respect to the mold.

As shown in FIG. 3, the mold 600 has a base 602. The base 602 is a rigid member whose longitudinal direction is perpendicular to the paper surface. FIG. 3 shows a section thereof. The base 602 is a precise rectangular parallelepiped free of bent or undulation in the longitudinal direction. The length of the base 602 is equal to the length of the C-channel 500.

A reference plate 604 is provided on one side face of the base 602 throughout the overall length of the side face. The reference plate 604 is a precise rigid member free of bent or undulation in the longitudinal direction. FIG. 3 shows a section thereof.

The reference plate 604 has a portion projecting upward from the base 602. The surface of this portion on the base 602 side is machined so as to be precisely perpendicular to an upper surface of the base 602. This surface provides a reference surface 604s of the mold 600. The reference surface 604s has a highly accurate flatness throughout the overall length thereof. The reference surface 604s has a width sufficient for positive abutment against a reference position of an object to be molded. The reference surface 604s is an example of the reference surface defined in the present invention.

A template 606 is provided on the other side face of the base 602 throughout the overall length of the side plate. The template 606 is a precise rigid member free of bend or undulation in the longitudinal direction. FIG. 3 shows a section thereof.

The template 606 has a portion projecting upward from the base 602. The surface of this portion on the base 602 side is machined so as to be precisely perpendicular to the upper surface of the base 602. This surface provides a mold surface 606s of the mold 600. The mold surface 606s has a highly accurate flatness throughout the overall length thereof. The mold surface 606s has a width sufficient to cover a molding range positively. The mold surface 606s is an example of the mold surface defined in the present invention.

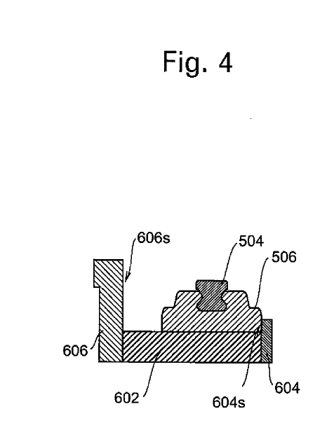

A main process for forming the metal adhesive layer 502 with use of the mold 600 constructed as above is shown in FIGS. 4 to 7. This process is an example of the best mode for carrying out the present invention. With this process, there is shown an example of the best mode for carrying out the present invention with respect to the part machining method.

As shown in FIG. 4, a rail block 504 is installed on the mold 600. The rail block 504 may be substituted by a block having the same structure. The rail block 506 is installed in a state in which one side face thereof is put in abutment against the reference surface 604s of the mold 600 throughout the overall length of the surface. In this state the rail block 506 is fixed. The rail block 506 abutted against the reference surface 604s provides a reference position.

The rail 504 is combined with the rail block 506, whereby the rail 504 and the rail block 506 provide the same structure as that of a linear guide.

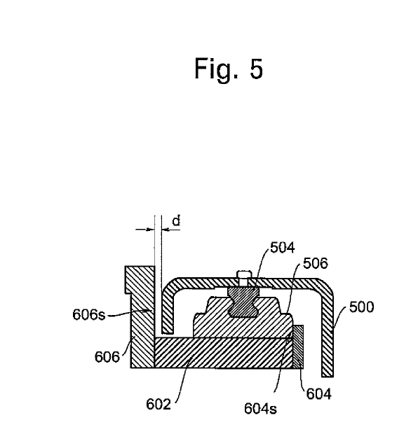

Next, as shown in FIG. 5, the C-channel 500 is placed on the rail 504 and is fixed with screws for example. As a result, one side face of the C-channel 500 is opposed to the mold surface 606s of the mold 600 through a gap d. The size of the gap d is, for example, about 2 mm.

Since the reference surface 604s of the mold 600 is in abutment against the reference position of the rail block 506 throughout the overall length of the reference position, the mold surface 606s is parallel highly accurately to the rail 504.

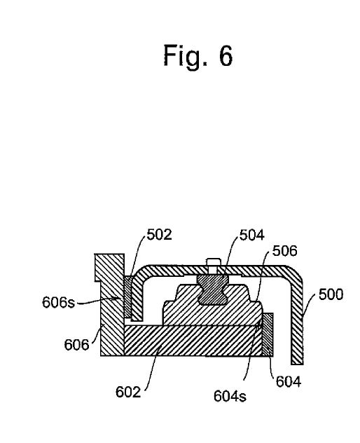

Next, as shown in FIG. 6, the metal adhesive agent 502 is filled into the gap d. A lower portion of the gap d is closed beforehand with an efflux preventing tape or the like. Rack mounting tapped holes formed in the C-channel 500 are processed beforehand for preventing the entry of the metal adhesive agent 502.

With the metal adhesive agent 502 filled into the gap d, curing is performed for example by standing at room temperature for about 24 hours. As a result, the metal adhesive agent 502 adheres and cures to the side face of the C-channel 500.

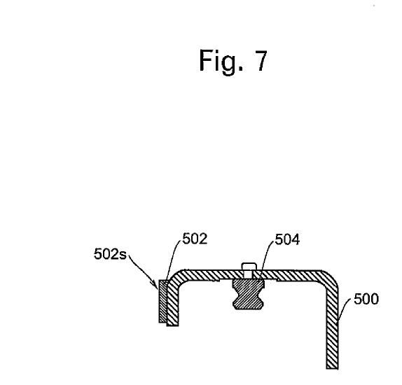

Thereafter, by removing the mold 600, the C-channel 500 with the metal adhesive layer 502 formed on the side face thereof is obtained as shown in FIG. 7. A surface 502s of the metal adhesive layer 502 is highly accurately parallel to the rail 504 because it is a replica of the mold surface 606s.

Lastly, by attaching the rack 402 to the surface 502s, the C-channel having the rack 402 on the side face thereof can be obtained as shown in FIG. 2. The rack 402 is highly accurately parallel to the rail 504.

Many widely different embodiments of the invention may be configured without departing from the spirit and the scope of the present invention. It should be understood that the present invention is not limited to the specific embodiments described in the specification, except as defined in the appended claims.

1. A part machining method comprising the steps of:
positioning a mold in such a manner that a flat mold surface is opposed to a surface of a long metal member in a state of non-contact substantially throughout the overall length of the surface;
filling a metal adhesive agent into the opposed portion between the long metal member and the mold; and
removing the mold after curing of the metal adhesive agent.

2. A part machining method according to claim 1, wherein the long metal member has a rectilinear rail in the longitudinal direction, and positioning of the mold is performed in relation to the rail in such a manner that the mold surface becomes parallel to the rail.

3. A part machining method according to claim 2, further comprising the step of mounting a rack to a surface of the metal adhesive agent corresponding to the mold surface in such a manner that the rack is parallel to the rail.

4. A part machining method according to claim 3, wherein the long metal member is a C-channel.

5. A mold comprising:
a reference surface capable of abutment against a reference position which is determined by a predetermined portion of a long metal member to be molded; and
a mold surface opposed in parallel to the reference surface through a predetermined spacing and capable of being opposed to a surface of the long metal member in a state of non-contact substantially throughout the overall length of the surface.

6. A mold according to claim 5, wherein the predetermined portion is a rectilinear rail attached to the long metal member longitudinally.

7. A long part comprising:
a long metal member; and
a metal adhesive agent molded to a surface of the long metal member substantially throughout the overall length of the surface so as to provide a Nat surface.

8. A long part according to claim 7, wherein the long metal member has a rectilinear rail in the longitudinal direction and the surface of the metal adhesive agent is parallel to the rail.

9. A long part according to claim 8, further comprising a rack mounted to the surface of the metal adhesive agent so as to be parallel to the rail.

10. A long part according to claim 9, wherein the long metal member is a C-channel.

11. A table apparatus comprising a top board and a moving mechanism for moving the top board rectilinearly in the longitudinal direction, the moving mechanism comprising:
a long metal member mounted to the top board longitudinally;
a rectilinear rail mounted to the long metal member longitudinally;
a rail block engaged with the rail;
a metal adhesive agent molded to a surface of the long metal member in parallel with the rail substantially throughout the overall length of the surface so as to provide a flat surface;
a rack mounted to the surface of the metal adhesive agent so as to be parallel to the rail; and
a pinion engaged with the rack.

12. A table apparatus according to claim 11, wherein the long metal member is a C-channel.

13. An X-ray imaging system comprising an X-ray irradiator, an X-ray detector and a table apparatus, the table apparatus comprising a top board and a moving mechanism for moving the top board rectilinearly in the longitudinal direction, the moving mechanism comprising:
a long metal member mounted to the top board longitudinally;
a rectilinear rail mounted to the long metal member longitudinally;
a rail block engaged with the rail;
a metal adhesive agent molded to a surface of the long metal member in parallel with the rail substantially throughout the overall length of the surface so as to provide a flat surface;
a rack mounted to the surface of the metal adhesive agent so as to be parallel to the rail; and
a pinion engaged with the rack.

14. An X-ray imaging system according to claim 13, wherein the long metal member is a C-channel.

15. A long part in accordance with claim 7 wherein the long metal member is configured to mount to a table apparatus of an X-ray imaging system.

16. A long part in accordance with claim 15 wherein the long metal member is configured to mount longitudinally to the table apparatus.

17. A long part in accordance with claim 15 wherein the long metal member is configured to mount to a top board of the table apparatus.

18. A table apparatus in accordance with claim 11 wherein the metal adhesive is applied in a layer having a thickness of approximately 2 mm.

19. An X-ray imaging system in accordance with claim 13 wherein the metal adhesive is applied in a layer having a thickness of approximately 2 mm.

20. A method in accordance with claim 1 wherein positioning a mold in such a manner that a flat mold surface is opposed to a surface of a long metal member further comprises positioning the long metal member at a distance of approximately 2 mm. from the flat mold surface.
